(19) United States
(12) Patent Application Publication
(10) Pub. No.: US 2023/0264204 A1
(43) Pub. Date: Aug. 24, 2023

(54) METHOD FOR OPTIMIZING MINERAL RECOVERY PROCESS

(71) Applicant: INTELLISENSE.IO LTD, Stow-Cum-Quy (GB)

(72) Inventors: Hugh MCNAMARA, Stow-Cum-Quy (GB); Mario Leon GATICA, Stow-Cum-Quy (GB); Balazs HORNUNG, Stow-Cum-Quy (GB); Cecilia LABORDE, Stow-Cum-Quy (GB)

(73) Assignee: INTELLISENSE.IO LTD, Stow-Cum-Quy (GB)

(21) Appl. No.: 18/041,007

(22) PCT Filed: Aug. 11, 2021
(86) PCT No.: PCT/IB2021/057395

§ 371 Date: Feb. 8, 2023

(30) Foreign Application Priority Data
Aug. 11, 2020 (EP) 20020367.7

(51) Int. Cl. B03D 1/02

(52) U.S. Cl. CPC B03D 1/028; B03D 2201/04; B03D 2203/02

(57) ABSTRACT

Disclosed is a method for optimizing a mineral recovery process from ore material using a flotation chamber. The method comprises implementing a machine learning model to determine operational parameters of the flotation chamber, for the mineral recovery process based on a geometry of the flotation chamber and properties of the ore material. The method further comprises simulating the mineral recovery process using ranges of the determined operational parameters to determine a factor representative of a relationship between a gas hold-up value and a bubble diameter value. The method further comprises calculating the gas hold-up value and the bubble diameter value based on determined the operational parameters and the determined factor. The method further comprises utilizing the determined gas hold-up value and bubble diameter value to determine optimized values of the operational parameters for the mineral recovery process by implementing a virtual sensor, to achieve higher throughput of recovered minerals from the ore material.

### TECHNICAL FIELD

The present disclosure relates generally to a mineral recovery process; and more specifically to a method for optimizing a mineral recovery process from ore material using a flotation chamber.

### BACKGROUND

Flotation is a process in liquid-gas-solid separation technology which has been widely used in the extraction of valuable minerals from ore materials. Herein, the solids in the suspension are removed by making them attach to gas bubbles. Flotation, also often termed as adsorptive bubble technique, may either utilize foaming technique or non-foaming technique. The foaming technique, also known as froth flotation, is a process, typically carried out in flotation chamber, also known as floatation cell, for separating minerals from ore material by taking advantage of differences in their hydrophobicity. In foaming technique, hydrophobicity differences between valuable minerals and other ore particles are increased through the use of surfactants and wetting agents, which lead to foam generation with gas bubbles.

The properties most important in determining the success of the froth flotation process are bubble diameter and extent of turbulence in the fluid (i.e., gas hold-up). Bubble diameter plays a critical role in the froth flotation process. It has been known that the rate of particle bubble collision, and hence particle collection, increases with decreasing bubble size depending on particle size distribution of the ore material. Since the particle size distribution is fixed constraining to techniques applied for ore processing, the generation of suitably sized bubbles is particularly important for flotation of fine particles (less than 10 μm in diameter) since the low rate of flotation of fines is due primarily to low particle-bubble collision probability. Thus, it is important to know, at least approximately, the average bubble size of an operating flotation process. Gas hold-up itself is potentially an important process variable. The rate of particle collection is a function of gas rate and bubble diameter, both of which affect gas hold-up. Therefore, it is important to control these variables for optimizing mineral recovery in the flotation chamber.

Conventionally, the bubble diameter is measured in laboratories which is quite costly. In order to have this measurement, it is common to hire a third-party service provider with costs involved in the process. Currently, there are no affordable sensors or instrumentation to measure the size of bubbles in the flotation chamber itself. Some photographic techniques are known for bubble diameter measurement. However, they are generally tedious, particularly at the relatively high gas hold-up encountered in flotation columns. Furthermore, such photographic techniques are not applicable to bubble size measurement in slurries. Thus, without proper means for measurement of bubble diameter in-situ, it may not be possible to optimize the bubble diameter by changing affecting factors. Similarly, the gas hold-up value, which is also one of the most important parameters characterising the hydrodynamics of the froth flotation process, depends mainly on the gas velocity, physical properties of the liquid and type of gas sparger used, and thus could not be easily regulated.

Traditionally, the process variables are regulated to achieve the desired bubble diameter and gas hold-up values by many hit-and-trials. That is, first the optimum bubble diameter required for achieving maximum ore efficiency is determined. Next the variables like, air flow rate, slurry density and the likes are tested for a number of values. The values of the variables for which the optimum bubble diameter is achieved is set for the flotation cell. However, even if one condition or parameter in the flotation cell changes, the whole process for obtaining the bubble diameter is repeated which is a tedious task.

Therefore, in light of the foregoing discussion, there exists a need to overcome the aforementioned drawbacks related to regulation of variables, such as bubble diameter and gas hold-up in the flotation cell for optimization of the mineral recovery process, as known in the art.

### SUMMARY

The present disclosure seeks to provide a method for optimizing a mineral recovery process. An aim of the present disclosure is to provide a solution that overcomes at least partially the problems encountered in prior art and provides a method for optimizing a mineral recovery process from ore material using a flotation chamber to extract minerals from the ore material efficiently.

In an aspect, the present disclosure provides a method for optimizing a mineral recovery process from ore material using a flotation chamber, the method comprising:
implementing a machine learning model, trained on historic data related to the mineral recovery process, to determine operational parameters of the flotation chamber, for the mineral recovery process based on a geometry of the flotation chamber and properties of the ore material;
simulating the mineral recovery process using ranges of the determined operational parameters for the mineral recovery process to determine a factor representative at least of a relationship between a gas hold-up value and a bubble diameter value for the mineral recovery process;
determining the gas hold-up value and the bubble diameter value based on the determined operational parameters and the determined factor; and
utilizing the determined gas hold-up value and bubble diameter value to determine optimized values of the operational parameters for the mineral recovery process by implementing a virtual sensor, to achieve higher throughput of recovered minerals from the ore material.

In one or more embodiments, the machine learning model is configured to find (identify) outlier data points in the data using robust z-scores, in turn cleaning the data (namely filtering or blocking outlier data points) prior to determining the operational parameters for the mineral recovery process.

In one or more embodiments, at least one of the gas hold-up value and the bubble diameter value are determined using a drift flux analysis

In one or more embodiments, the mineral recovery process is simulated using computational fluid dynamics techniques.

In one or more embodiments, the operational parameters comprise operational variables as determined by the machine learning model and initial variables as determined from the operational variables.

In one or more embodiments, the computational fluid dynamics techniques utilize ranges of the initial variables to determine the said factor.

In one or more embodiments, the operational variables comprise one or more of air flow (Qg), wash water flow (Qw), slurry flow (Qt) and percentage of solids (Cp), and wherein the determined initial variables comprise one or more of superficial air speed (Jg), superficial liquid speed (Jl), slurry density (Dp), viscosity (Vis) and temperature (T), wherein it is also possible to add other variables, such as reagent dose.

In one or more embodiments, the method further comprises training the machine learning model based on the determined gas hold-up value and bubble diameter value to control the operational parameters of the mineral recovery process.

In a second aspect, the present disclosure provides a system for implementing the method for optimizing a mineral recovery process from ore material using a flotation chamber.

In a third aspect, the present disclosure provides a computer program product comprising instructions which, when the program is executed by a computer, cause the computer to carry out the method for optimizing a mineral recovery process from ore material using a flotation chamber.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a diagrammatic illustration of an exemplary flotation chamber, in accordance with one or more embodiments of the present disclosure;

FIG. 2 is a graphical depiction of a relationship between a bubble surface area flux (Sb) and zinc (Zn) recovery as implemented in a flotation chamber, in accordance with one or more embodiments of the present disclosure;

FIG. 3 is a graphical depiction of a relationship between a Sauter diameter (d32) and a frother concentration for different chemicals as implemented in a flotation chamber, in accordance with one or more embodiments of the present disclosure;

FIG. 3 is a graphical depiction of a relationship between a Sauter diameter (d32) and a frother concentration for various mixtures of pentanol and Methyl isobutyl carbinol (MIBC) as implemented in a flotation chamber, in accordance with one or more embodiments of the present disclosure;

FIG. 4 is a block diagram of a machine learning model for extraction of minerals, in accordance with one or more embodiments of the present disclosure;

FIG. 6 is a block diagram of system for implementing mineral recovery process, in accordance with one or more embodiments of the present disclosure;

FIG. 7 is a flowchart of a method for optimizing a mineral recovery process, in accordance with one or more embodiments of the present disclosure; and

FIG. 8 is a process flow diagram of a mineral recovery process, in accordance with one or more embodiments of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In an aspect, the present disclosure provides a method for optimizing a mineral recovery process from ore material using a flotation chamber, the method comprising:
implementing a machine learning model, trained on historic data related to the mineral recovery process, to determine operational parameters of the flotation chamber, for the mineral recovery process based on a geometry of the flotation chamber and properties of the ore material;
simulating the mineral recovery process using ranges of the determined operational parameters for the mineral recovery process to determine a factor representative at least of a relationship between a gas hold-up value and a bubble diameter value for the mineral recovery process;
determining the gas hold-up value and the bubble diameter value based on the determined operational parameters and the determined factor; and
utilizing the determined gas hold-up value and bubble diameter value to determine optimized values of the operational parameters for the mineral recovery process by implementing a virtual sensor, to achieve higher throughput of recovered minerals from the ore material.

The present disclosure provides a method for optimizing a mineral recovery process from ore material using a flotation chamber. As used herein, the term “flotation chamber” relates to any device or structure which implements flotation technology for extraction of ore. The flotation chamber is generally a two-stage system with 3, 4 or 5 flotation cells in series, as known in the art. Hereinafter, the terms “flotation chamber” and “flotation cell” have been interchangeably used without any limitations.

Flotation is a physical separation process for separating fine-grained mixtures of solids (e.g. ores and gangue) in an aqueous slurry or suspension using air bubbles, based on the different surface wettability of the particles contained in the suspension. It is used for the beneficiation of mineral resources and in the processing of preferably mineral substances containing low to average amounts of a wanted component or valuable material (e.g. in the form of nonferrous metals, iron, rare earth metals and/or noble metals) as well as non-metallic mineral resources. However, the use of flotation is also generally well known in other technical fields such as waste-water treatment, for example.

In particular, froth flotation in mineral processing industry is widely used for the extraction of a specific type of mineral from ground ore while depressing the amount of undesired minerals (gangue) in the concentrate. Froth flotation enables mining of low-grade and complex ore bodies that otherwise would be disregarded due to lack of profitability. As discussed, froth flotation is a process typically carried out in flotation chambers, for separating minerals from ore material by taking advantage of differences in their hydrophobicity. These differences can occur naturally, or can be controlled by the addition of a collector reagent. Froth flotation generally involves the use of air injection through a slurry that contains water, minerals and gangue particles within a vessel. Dispersed air bubbles attract the hydrophobic valuable minerals and carry them upward to the top of the flotation chamber, whereupon they form a froth bed or froth layer which contains and supports pulverised mineral. The froth is then scraped or permitted to flow over the lip of the chamber to cause the separation. The thus concentrated mineral bearing froth is collected and further processed to improve the concentration of desired minerals. The pulp may be further processed to recover other valuable minerals.

Typically, the flotation chamber (hereinafter, sometimes, referred to as “flotation column”) is a cylindrical column having a deep foam layer. The flotation chamber, generally, includes an arrangement of multiple floatation cells which may be combined in series and working in conjunction to carry out the mineral recovery process, and the two terms “flotation chamber” and “flotation cell” have been interchangeably used hereinafter. The flotation chamber is divided into two zones, a collection zone and a cleaning zone. The end of floatation chamber having the collection zone is provided with a pipe for gas flow. A slurry of ore from which valuable minerals need to be extracted are placed at the bottom of the collection zone. Next activators may be added to the slurry. Activators are chemicals that attaches with the valuable minerals of the ore so that other reagents may react with it. For example, in an embodiment for extraction of zinc from zinc ore, copper sulphide is used as an activator. Herein, the cupper sulphide will attach with the zinc particles of the zinc ore so that other reagents may react with it.

After the activators have attached to the respective valuable minerals of the ore, collectors are added. The collectors are a type of chemical that attaches to the valuable minerals of the ore that are needed to be extracted in order to make them hydrophobic. Hydrophobic particles are those that fear water and have tendency to attach to similar particles rather than water. That is, the hydrophobic particles repel water molecules. Herein, the collectors attach itself to the valuable minerals of the ore in order to make them hydrophobic. This is necessary for bubble attachment. Collectors can generally be classified into three categories—non-ionic, anionic or cationic. Non-ionic collectors are simple hydrocarbon oils. Anionic and cationic collectors consist of a polar component.

Once the valuable minerals are made hydrophobic, air is injected into the collection zone from the bottom. The air blown causes development of froth with bubbles in the collection zone. Since, the valuable minerals of the ore are hydrophobic they attach to the bubbles and are transported up the column into the foam layer. The volume of the foam layer forms part of the cleaning zone. The hydrophilic particles of the ore have affinity for water, and they remain in the slurry. However, some hydrophilic particles may be entrapped between the hydrophobic valuable minerals. In order to get rid of these entrapped hydrophilic particles from the valuable minerals, water is injected from the top of the cleaning zone. The entrapped hydrophilic particles are attracted to the injected water and are thus washed away into the suspension. The leftover valuable minerals are collected.

As discussed, the flotation chambers are used in various applications, such as, but not limited to extraction of metallic and non-metallic ores. The main purpose of the flotation chamber is the improvement of final concentrate grade to a level that would not be possible using conventional flotation. In many cases, the use of column flotation enables a concentrate to achieve separation that is closer to perfect than any other type of froth flotation device. The true advantage of such flotation chamber comes in the form of profitability. Flotation chamber allows mineral beneficiation of plants to achieve higher profits of their concentrate by purifying concentrate, thereby lowering shipping costs, decreasing plant footprint and reducing smelter penalties. Low operating and maintenance costs due to the absence of mechanical moving parts are other advantages of the flotation chambers. Operation of the flotation chamber is affected by three major components, namely chemistry component, operating component and equipment component.

Herein, the chemistry component of the flotation chamber includes, but not limited to, collectors, frothers, activators, depressants, etc. which are various chemicals added to the flotation chamber for effective extraction of ore. As discussed, the collectors are the chemicals which attaches with the valuable minerals of the ore in order to make them hydrophobic. The activators are chemicals which are added to aid attachment of other chemicals, such as, collectors with the valuable minerals of the ore. The depressants are chemicals which prevent the valuable minerals of the ore from floating in the flotation chamber. The frothers are chemicals which increase the surface tension of the injected air. In order to obtain effective extraction of the valuable minerals from the ore, the power of hydrogen (pH) of the flotation chamber should also be maintained. The pH is a scale that measures how alkaline or how acidic the chemical is.

The pH of a neutral water solution is 7. If the solution is acidic pH is less than 7 and for a basic solution the pH is greater than 7. The pH is used to control which minerals of the ore need to be extracted. Under different pH condition different minerals are attracted to the collectors. For example, when pH is less than 7, that is, if the solution is acidic, the minerals of the ore develop positive charge. However, if the pH is greater than 7, that is if the solution is alkaline, the minerals of the ore generally develop negative charge. Hence, under different conditions, different minerals of the ore will be attracted to the collectors. Thus, by controlling the pH selective minerals may be extracted from the ore. The pH of the solution may be controlled by adding pH modifiers.

Further, the operating component of the flotation chamber includes operating conditions in the flotation chamber, such as feed rate, mineralogy, particle size distribution, pulp density and temperature. The operating conditions are the conditions that should be maintained in the flotation chamber in order to obtain extraction of valuable minerals from the ore. Herein, the feed rate of the flotation chamber is rate at which the ore is fed to the flotation column. The feed rate depends on the type of the ore to be extracted and on the parameters of column flotation chamber. For effective extraction an optimum feed rate should be maintained. The particle size distribution is the average size of particles of the ore and all the other chemical components added to the flotation chamber. For effective extraction of minerals, optimum particle size distribution should be maintained. The pulp density is the density of the slurry present in the flotation chamber. It is a measure of the amount of solid in the pulp or slurry. Typically, pulp density denotes the weight of a unit volume of pulp. It may be understood that, for effective extraction of the valuable minerals of the ore, the optimum temperature of the flotation chamber should also be maintained.

Furthermore, the equipment component of the flotation chamber includes chamber design, air flow, chamber bank configuration and chamber bank control. Numerous designs of the flotation chamber are used for extraction of minerals from the ore. The chamber design varies from manufacturer to manufacturer. Chamber bank configuration is the arrangement of a plurality of flotation cells used for extraction of minerals from the ore material, as separated in the process described above.

Optionally, an agitation in the flotation chamber is controlled by a rotator-stator system. During agitation, the particles in the pulp are stirred increasing the probability of contact between the hydrophobic particles with the air bubbles (particle-bubble collision). The rotator-stator system may be configured to avoid creation of turbulence in the slurry, which may in turn affect the bubble size distribution.

It may be contemplated that all the components of the flotation chamber are interrelated. Change(s) in any one component needs change(s) in other components for maintaining efficient process. For example, even if only the air flow rate changes the particle size distribution and most of the other parameters should also be changed for effective extraction of minerals from the ore material. It is therefore important, as the inventors have realized, to take all of these factors into account in froth flotation operations. Changes in the settings of one factor will automatically cause or demand changes in other parts of the system. Therefore, in order to obtain higher efficiency in spite of changes in any one factor, all other parts of the system should be automatically adapted based on the feedback from the calculations. As a result, it is difficult to study the effect of any single factor without consideration of interaction effect. Based on available research, the most important factors required to be regulated for efficient extraction of minerals from the ore are the bubble diameter value and the gas hold-up value. In order to have higher extraction of the minerals from the ore material, it is important to optimize the bubble diameter value and the gas hold-up value. Any deviation from the optimum value decreases the efficiency of the mineral recovery process in the flotation chamber.

It is to be noted that flotation chambers present challenging problems with respect to the design and installation of sensors associated with the flotation chambers, the acquisition of various measurements, the ability to communicate data and power into and out of the flotation chamber, as well as the ability to provide control devices within the chamber and actuate those control devices in response to a command from a central control computer. A special challenge has been to improve efficient control of the various above-discussed parameters Each of these parameters must be adjusted to optimize both the economic operation of the plant, as well the operating conditions, i.e., efficient throughput and desired levels of purification. Flotation chambers are normally controlled by simple, feedback or feed forward control loops. Various devices have been described which may be used to monitor important parameters in flotation chamber operation. The most common of these describe a separation control system comprising a controller (e.g., a microprocessor) which communicates with one or more sensors and in response to information received from the sensors, actuates a control apparatus (e.g., a valve) to adjust one or more control parameters.

Conventionally, the parameters of the flotation chamber, where the extraction of valuable minerals takes place, is varied by hit and trial method till optimum value for the bubble diameter and the gas hold-up is obtained. Such process is very tedious, costly and time-consuming. Moreover, if any of the parameter changes the bubble diameter value and the gas hold-up value drifts from the optimum value and the whole process needs to be repeated.

The method of the present disclosure comprises implementing a machine learning model, trained on historic data related to the mineral recovery process, to determine operational parameters for the mineral recovery process based on a geometry of the flotation chamber and properties of the ore material. Machine learning is a subset of artificial intelligence. Herein, the machine learning model learns to perform certain activities from the provided historic data set so that it can perform similar tasks in future without having programmed to do so. That is, instead of programming every time to perform a task, the machine learning model learns the process through the historic data and performs its task depending upon its intelligence.

While the area of machine learning models is highly specialized and relatively new, those familiar with and skilled in their use have a thorough understanding of their underlying principles and practical implementation. Some representations of machine learning are loosely based on interpretation of information processing and communication patterns in a biological nervous system, such as neural coding that attempts to define a relationship between various stimuli and associated neuronal responses in the brain. A machine learning model typically employs an artificial neural network (ANN) with multiple hidden layers between the input and output layers. The machine learning model architectures generate compositional models where the object is expressed as a layered composition of primitives. The extra layers enable composition of features from lower layers, potentially modelling complex data with fewer units than a similarly performing shallow network. Machine learning models use a cascade of many layers of nonlinear processing units for feature extraction and transformation. Each successive layer uses the output from the previous layer as input.

In order to perform tasks, the machine learning model has to be trained first. The training is done by employing learning algorithms. There are three major learning algorithms. They are supervised learning algorithm, unsupervised learning algorithms and reinforcement learning algorithm.

The supervised learning algorithm is like a teacher student learning. Herein, a set of historical input data along with respective outputs are given. The historic data are treated as examples and the machine learns a rule that maps the input data with the respective outputs. In unsupervised learning, outputs for the historical input data are not provided and the machine learns without supervision. In reinforcement learning no historic data sets are provided and the machine learns with “experience”.

As aforementioned, in order to implement the machine learning model in the method for optimizing the mineral recovery process, first the model needs to be trained. The training is done on the basis of the historic data related to the mineral recovery process. The historic data is set of data collected from past events. Generally, the historic data includes the values of inputs used in the mineral recovery processes carried out in the past and the respective the values of outputs obtained therefrom. The historic data is often saved for future references. The historic data may be used for deriving important insights about the past mineral recovery processes. Herein, one can deduce that according to what input the desired output is obtained. Similarly, analysing of historic data helps in determining the input conditions for which the apparatus has highest throughput. In machine learning, the historical data are primarily used to train the model.

In one example, the historic data includes a set of data having geometry of the flotation chamber, properties of the ore material as input and operational parameters for the mineral recovery process as the respective output. The geometry parameters include a column height (Hc) and a column diameter (Dc) of the flotation chamber. Herein, the column height (Hc) is the height of the column in the flotation chamber, being used for mineral recovery process purposes. The column diameter (Dc) of the flotation chamber is the diameter of the column. The ore properties include a solid density (Ds) and a liquid density (Dl) of the feed of the ore material provided in the flotation chamber. Typically, the geometry parameters and the ore properties are measured manually. It may be contemplated that, all three phases, that is, solids, liquids and gases are present in the flotation chamber.

The flotation chamber of the present disclosure is provided with one or more virtual sensors for the sensing of one or more parameters related to the processes and operation of the mineral recovery process. Herein, the virtual sensors may not be physical sensors (as conventionally used) but may be in the form of software modules which may determine (instead of measure) the parameters related to the processes and operation of the mineral recovery process based on available input variables information. For example, the virtual sensors may be provided for measuring air flow rate (Qg), wash water flow rate (Qw), slurry flow rate (Qt) and percentage of solids (Cp). In addition, a computerized control system which may be located at the flotation chamber, near the flotation chamber, or at a remote location from the flotation chamber is provided for interaction with the sensor or sensors in the flotation chamber. This computer control system includes a control computer and one or more control devices which are actuated in response to a command signal from the control computer. Importantly, the response of the computer control system will preferably be based both on sensor input and on a series of expert rules, determined initially in advance and continually updated based upon the control system's own analysis of its performance. The controller will generate and continuously update its own process model, using the data inputs described and one, some or all of several advanced analysis techniques, including neural networks, genetic algorithms, fuzzy logic, expert systems, statistical analysis, or a combination of any of these. The control system will have the ability to independently select the best analysis technique for the current data set of the flotation chamber. The computer control system will actuate one or a plurality of control devices based on input from one or more monitoring sensors so as to provide real time, continuous, operational control. In addition, the control system may include a monitoring system for data logging, preventative maintenance, or failure and wear prediction. The control system may additionally include diagnostics relating to the condition of the flotation chamber.

It may be appreciated that some of the operational parameters may be known and some may be programmed at site. Examples of information already known include information relating to the operation and maintenance of the flotation chamber and operator training information, all of which will be readily available. Examples of information programmed at the site where the flotation chamber is to be used include the operating ranges, equipment parameters, and desired feed parameters, along with other site-specific data and environmental factors. Inputs may also include various process models, process controls, and guidelines. These models and goals may be either stored in memory or programmed at the site as appropriate.

Optionally, the operational parameters comprise operational variables as determined by the machine learning model and initial variables as determined from the operational variables. That is, the obtained or determined operational variables are used to determine the initial variables. Herein, the operational variables comprise one or more of air flow (Qg), wash water flow (Qw), slurry flow (Qt) and percentage of solids (Cp), and wherein the determined initial variables comprise one or more of superficial air speed (Jg), superficial liquid speed (Jl), slurry density (Dp) and viscosity (Vis). As discussed, the air flow rate (Qg) is the rate at which the air flows into the flotation column. The air flows produce froth in the flotation column. The wash water rate (Qw) is the rate at which water is injected into the cleaning zone of the flotation column. The slurry flow rate (Qt) is the rate at which slurry is inserted into the flotation column for extraction of valuable minerals. The percentage of solids (Cp) is the relative measure of solids present in the slurry. The superficial air speed (Jg) is the speed of the air in the flotation chamber considering that only the gaseous phase is present in the flotation chamber. Similarly, the superficial liquid speed (Jl) is the speed of the liquids present in the flotation chamber considering that only the liquid phase is present in the flotation chamber.

It may be appreciated that the trained machine learning model can achieve this using the historic data, and the available information about geometry properties of the floatation chamber and the provided ore properties. In order to do so the machine learning model looks through the historic data to check whether the input data set of the flotation chamber (as discussed above) matches, at least partially, with one or more of the input values set in the historic data set; and if it matches, the machine learning model can determine the respective output data set. As aforementioned, the machine learning model uses the historic data which includes a set of values of column height (Hc), column diameter (Dc), solid density (Ds) and liquid density (dl) as inputs. For each historical input data set, corresponding achieved conditions data set may also be provided. Such data set may include operational conditions as used for efficient operation, such as, but not limited to, air flow rate (Qg), wash water flow rate (Qw), slurry flow rate (Qt) and percentage of solids (Cp). Further, the initial conditions as achieved in the flotation chamber, such as, but not limited to, superficial air speed (Jg), superficial liquid speed (Jl), slurry density (Dp) and viscosity (Vis) may also be available from such dataset.

Optionally, the machine learning model computes robust z-scores for determining the operational parameters for the mineral recovery process. Herein, z-score is a measure of how many median absolute deviations below or above the population median a raw score is. Simply put, a z-score (also called a standard score) gives you an idea of how far from the median a data point is. Thus, z-scores provide a way to compare results to a “normal” population. This way the machine learning model is able to filter outliers in the dataset which may have been caused due to incorrect measurements, faulty sensors or the like, and thus could maintain the integrity of the dataset of learning and calculation purposes.

In the present embodiments, the machine learning model executes robust z-score analysis (computes robust z-score) to identify and remove (namely delete) outlier data points with one or more filters to be used as thresholds, which in turn only allow the inclusion of datapoints that provide an optimised range for recovery of minerals from the ore material based on the historic data (called ‘valid datapoints’). Such values (or ranges) are dependent on historical data and information input, which may also include the amount recovered over a given period during operation. Since bubble size distribution is an information not available for the process operators, the virtual sensor (in the form of one or more software or software modules) combines machine learning model with Drift Flux calculations to calculate the bubble size distribution of the process under operating conditions. In some examples, the process uses a known mathematical relationship (Sb≈5.5 Eg) to optimize the process for the given particle size distribution (which, as discussed, once added to a flotation system it cannot be changed). The process is then optimised by a filter arrangement (which can be a software or a device plus a software, for example a machine learning software that executes the filter) that filters only allow data input (namely information input) into the process to operate in ranges considered optimum. The filter arrangement may also comprise a cryptographic function (coding) and access key (decoding key) to allow manual override for example, for security purposes.

The method further comprises simulating the mineral recovery process using ranges of the operational parameters for the mineral recovery process to determine a factor representative at least of a relationship between a gas hold-up value and a bubble diameter value for the mineral recovery process. Herein, the gas hold-up is the amount of the gas present in the flotation chamber. In order to obtain maximum efficiency for the mineral recovery process, the bubble diameter and the gas hold-up should be maintained at respective optimum values. As discussed, the gas hold-up and the bubble diameter value are vital for optimizing the mineral recovery process; however, even if any one of the parameters changes the bubble diameter and the gas hold-up is affected. The calculated factor providing the relationship between the gas hold-up value and the bubble diameter value for the mineral recovery process could be used to control one using the known value for the other in the mineral recovery process.

Optionally, the mineral recovery process is simulated using computational fluid dynamics techniques. The computational fluid dynamics (CFD) is a tool for calculating the parameters of the multiphase flow, as present in flotation chambers, using numerical analysis. The term “multiphase flow” is referred to any fluid flow consisting of more than one phase or fluid type. Physical phases present in a flotation chamber are gas, liquid and solid; however, in multiphase flow, a phase can be described as an identifiable class of material that has a particular inertial response to and interaction with the flow and the potential field in which it is immersed. CFD has provided the basis for further insight into the hydrodynamics of multiphase flows. It is to be understood that the flotations conditions for CFD model are kept at laminar flow. It should be noted that the CFD model may not be possible to be applied in real-time, although the CFD modelling techniques are well defined and theoretically robust. A key point is that it is not possible to use CFD as an in-line method, since each calculation takes significant amount of time. Therefore, the said factor (f) is pre-calculated to provide relationship between the gas hold-up value and the bubble diameter value for the mineral recovery process.

Optionally, the computational fluid dynamics techniques utilize ranges of the initial variables to determine the said factor. In one example, the maximum and minimum values of the superficial air speed (Jg), the maximum and minimum values of the superficial liquid speed (Jl), the average value of the slurry density (Dp) and the average value of the viscosity (Vis) are used. Further, in the present examples, the CFD model uses geometrical properties of the flotation chamber. For this purpose, the CFD model implements mesh technique as well known in the art. The CFD model further uses information about ore properties including ranges and percentage of particles, and varies air and water percentages. Several scenarios of the model are determined using CFD technique, in which a typical range of superficial air speed (Jg) (i.e. a parameter of air flow per unit area) and superficial liquid speed (Jl) (i.e. slurry flow per unit area) are used along with average percentage of solids measured in the flotation chamber, and thus the modelling is independent of the size of the column section. These range variables are used by the CFD technique to estimate/predict a possible gas hold-up value (E′g), which in turn is used to calculate the said factor. Herein, Relationships of the dimensionless type or per unit area are used, for example Jg/Eg versus Jl, Jg or db; and in this way, a relationship between the bubble diameter (db) and the gas hold-up (Eg) is obtained.

The method further comprises determining the gas hold-up value and the bubble diameter value based on the operational parameters and the determined factor. As discussed, the bubble diameter (db) is the average diameter of the gas bubbles present in the flotation column. It is also measured by Sauter bubble diameter. The Sauter bubble diameter (d32) is the ratio of the cube of the diameter and the square of the diameter. That is, the Sauter bubble diameter is proportional to the ratio of the volume of bubble diameter and its surface area. The manner in which the mean bubble size changes depends on the air dispersion capability of the floatation chamber. Further, it is known that the gas hold-up (Eg) increases when the gas is efficiently dispersed. In this case, when the gas dispersion is carried out, the liquid flow patterns have a predominant effect. The increase in gas hold-up value (Eg) can be explained by the increase in circulation of the liquid and the decrease in bubble size. In mechanical flotation machines, which have been in industrial use for several decades, gas bubbles are generated by shear at the impeller edges. It is generally accepted that they produce small bubbles (less than 0.1 cm diameter) very effectively and consistently. In flotation columns, however, bubble generation through spargers has not been consistent and has been a source of design and operating difficulties.

Optionally, at least one of the gas hold-up value and the bubble diameter value are determined using a drift flux analysis. The concept of drift flux analysis has been used to estimate mean bubble size in bubble columns and flotation columns, and was introduced to relate phase flow rates, gas hold-up and physical properties. From the drift flux analysis, an estimate of terminal bubble rise velocity is obtained which in turn can be used to calculate the bubble diameter. Using drift flux analysis bubble size can be estimated from measurements of Eg, Jg and Jl. The technique of drift flux analysis and its implementation in the art of froth flotation process for calculation of one or more of the gas hold-up value and the bubble diameter value is well known and thus has not been explained in detail herein for the brevity of the present disclosure. In some examples, the gas hold-up value and/or the bubble diameter value values may alternatively be determined using mass flux or other suitable techniques without departing from the scope of the present disclosure. It may be understood that the determined value may be used with the calculated factor, specifically substituted in the factor to calculate the other value.

For example, the determined bubble diameter value is substituted in the factor (f) to determine the gas hold-up value (Eg).

Herein, the determined gas hold-up value and bubble diameter value are further utilized to determine optimized values of the operational parameters for the mineral recovery process. Herein, the machine learning model can be implemented as a recovery model to use the gas hold-up value (Eg) to determine the operational parameters. For instance, in an example, the mineral to be extracted is copper. Herein, the inputs to the recovery model are the derived gas hold-up value (Eg) for the live plant, and the operational variables obtained are superficial air speed (Jg), superficial liquid speed (Jl), wash water flow (Jw), froth level (Hf), distributor level (Hd), tank level (He), amount of Xanthate (Xa), NaHS or sodium hydrosulphide concentration (Na), acidity level (pH), grade of copper (LCu), percentage of solids (PS), and temperature (T). Similarly, the machine learning model can be implemented as a material model to use the residence time value (Rt) to determine the operational parameters, specifically the operational variables obtained are, grade of copper (LCu), mass flow (QM) and percentage of solids (PS). The value of the variables thus obtained are required conditions to be maintained in the live plant in order to obtain the optimal bubble diameter and gas hold-up needed for maximum efficiency. The parameters of bubble diameter and gas hold-up can be added to recovery models built with machine learning to analyse the behaviour of the column chamber and modify variables such as pulp flow, air flow, dosage and types of additives, etc, and study its effects and optimize, for example, recovery within a final copper grade range.

Optionally, the method further comprises training the machine learning model based on the determined gas hold-up value and bubble diameter value to control the operational parameters of the mineral recovery process to achieve higher throughput of recovered minerals from the ore material. For this, the values for bubble diameter (db) and Sauter bubble diameter (d32), bubble surface area flux (sb), residence time (Rt) and gas hold-up (Eg), etc. are obtained. It may be understood that the obtained bubble diameter value (db), Sauter bubble diameter value (d32) and gas hold-up value (Eg) are the optimal values and should be maintained for efficient separation of minerals from the ore material. In order to do so, the corresponding optimal values for variables such as, but not limited to, superficial air speed (Jg), superficial liquid speed (Jl), wash water flow (Jw), froth level (Hf), distributor level (Hd), tank level (He), acidity (pH), percentage of solids (PS) and temperature (T) are also determined. In the present embodiments, instead of manually testing by hit and trial method, the values of the variables are determined by using the machine learning model. The trained machine learning model (i.e., the output of the machine learning software after training based on the determined gas hold-up values and bubble diameter values for given particle size distributions and other process constrains) acts as a filter, and as such prevent the mineral recovery process from operating under sub-optimal ranges by not allowing information input (operation) in such less efficient ranges.

As discussed, the particle size distribution of the ore material is fixed for a batch supplied to the flotation chamber constraining to techniques applied for ore processing, the bubble size distribution needs to be adjusted for maximum recovery of minerals from the ore material. Currently, the bubble size distribution is not known to process operators (personnel) and thus optimization is carried out manually using prior experience, which may not be effective in all cases.

Further, as aforementioned, even if one of the variables of the mineral recovery process changes, the gas hold-up value and bubble diameter value are also affected, which in turn affect the throughput of the mineral recovery process. Hence, in order to maintain the gas hold-up value and bubble diameter value at optimum levels, the values of the operational parameters are adapted in the mineral recovery process in-situ. That is, according to the gas hold-up value and bubble diameter value, the operational parameters of the mineral recovery process are regulated.

Such information is not available for process operators (or process engineers) using physical sensors. Furthermore, the existing computational power is still not enough for almost all computers, even enhanced computer systems (thus not practical) for calculating during operation bubble size diameters using first principles, for example using computational fluid dynamics (CFD). For this reason, flotation processes are optimized via operator trial and error, which lead to inefficiencies since the ranges of essential parameters such as an amount of mineral, water, air (i.e. air-flow) and froth for a given column are interdependent when optimization is sought. For example, it is essential that such parameters are optimized under laminar flow conditions. Furthermore, it may be understood each particle size range will have an optimum bubble size range for recovery, which in turn, is set by the overall froth concentration and air flow. The present disclosure optimizes the bubble-size distribution for a given particle size distribution under process conditions, thus avoiding drawbacks of manual (namely operator) optimization such as turbulent flow regimes or sub-optimal concentration ranges.

The present disclosure provides techniques to determine such optimal values of the operational parameters and may thus act as virtual sensors for the flotation chamber to allow for setting of the corresponding values. In one embodiment, the optimal values of the operational parameters may be set manually. In another embodiment, the optimal values of the operational parameters may be set an automatic feed-back loop. That is, the optimization process can be automated, and adjustments can be made to the control system, to obtain the desired recovery within the restrictions imposed. Such technique is known in the art and thus has not been discussed herein.

The method of the present invention and the system for its implementation optimize a mineral recovery process via flotation by filtering (or blocking) information input into the system with respect to less efficient operation ranges and, thus, preventing operation within such less efficient ranges. This is achieved via the implementation of virtual sensors comprising a combination of a machine learning model and Drift Flux-type calculations for calculating the bubble size distribution of a flotation process under a given process constrains and for a given set of operating conditions. Herein, the virtual sensors, in the form of one or more software or software modules, perform the calculation in an inventive way, namely, using robust z-scores and drift-flux techniques to determine the optimized values for the mineral recover process. The trained machine learning algorithm thus acts as the filter for preventing the mineral recovery process from operating under sub-optimal ranges by not allowing information input (operation) in such less efficient ranges, resulting in process optimization and higher recovery not achieved by manual operation of the mineral recovery process.

The method for optimizing a mineral recovery process from ore material using a flotation chamber is advantageous to ore manufacturer as the purity of the recovered mineral is improved, time consumed for optimizing the mineral recovery process is reduced and the cost incurred for measuring the bubble diameter and hold up is substantially decreased. However, many a times other than valuable materials lots of other elements also attaches to the foam. Hence, the extracted minerals are highly impure. These impure extracted minerals are transported to purification factory. As the impurity of the extracted minerals is quite high, the weight of the extracted minerals is also high. This leads to an increase in transportation cost. Hence, in order to cut off the high transportation cost it is important to increase the efficiency of the flotation chamber. That is, the valuable minerals must be extracted from the ores at maximum possible purity level. In order to do so, it is important to set appropriate bubble to size particle ratio and the extent of turbulence in the fluid.

The deficiencies of the previous solutions are the absence of data to take actions in the plant. Decisions to improve recovery are made only on the basis of operator experiences. The problem is that an operator can only make these adjustments in real-time by trial and error or by implementing a significant number of physical sensors. The known solutions have the data, but they do not have the most important parameters that describe the behaviour of a chamber, these are the bubble diameter and the gas hold-up, therefore the actions to be taken to improve the recovery, are not reliable. More accurate solutions with the bubble diameter and the gas hold-up are implemented only in laboratories and at research level.

As mentioned above, the knowledge of the bubble size allows the optimization of the ore recovery. The proposed method solves this problem through mathematical models that can predict the bubbles size from ordinary input parameters measured in the flotation plant. The implementation of the above models inside an Artificial Intelligence platform associated with the use of Machine Learning techniques for analysis constitutes an innovative way over the existing solutions. It is estimated that the methodology developed will allow an increase between 2% to 3%, which means a significant increase in the revenue of a mine, for example. Higher efficiency means less energy, emissions, surfactants and waste in the process. In case of a mine operation, it means less waste generated and stored, with consequent reduction in accidents. Also, due to the fact that the bubble size is determined with currently measured parameters from the plant, that means less human contact with processes that can cause harm to human health.

The present disclosure provides an algorithm that solves a numerical problem in a defined sequence to find the average bubble diameter and the gas hold-up using typical and easily available industrial data available at flotation plants such as, column diameter, column height, solid density, liquid density, air flow, pulp or slurry flow, wash water, percentage of solid and froth level among other. This information is fed back into the system and the process is optimized beyond what can be achieved with manual or known methods. The values are modelled in real-time without the need of large number of physical sensors. The method provides ability to incorporate readings from existing and new sensors. Thus, the present method provides optimization of the operation of the columnar chambers to ensure quality of the final concentrate ad reduce variability to achieve higher throughput of recovered minerals from the ore material.

Aspects of the invention may be embodied in a number of forms. For example, various aspects of the invention can be embodied in a suitable combination of hardware, software and firmware. In particular, some embodiments include, without limitation, entirely software, entirely firmware or some suitable combination of hardware, software and firmware. In a particular embodiment, the invention is implemented in a combination of hardware and firmware, which includes, but is not limited to firmware, resident software, microcode and the like.

Additionally, and/or alternatively, aspects of the invention can be embodied in the form of a computer program product that is accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by, or in connection with, the instruction execution system, apparatus, or device.

### DETAILED DESCRIPTION OF THE DRAWINGS

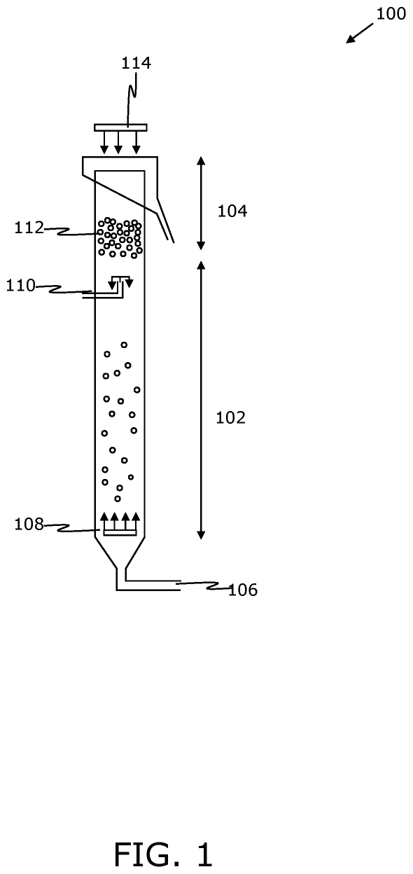

Referring to FIG. 1, there is shown a diagrammatic illustration of an exemplary flotation chamber, or columnar flotation chamber 100, in accordance with one or more embodiments of the present disclosure. The flotation chamber 100 is divided into two parts, a collection zone 102 and a cleaning zone 104. The collection zone 102 comprises a tailing 106, a gas injector 108 and a feed 110. The ore is injected into the columnar flotation chamber 100 through the feed 110. The gas injector 108 injects gas which creates bubbles in the columnar flotation chamber 100. In the collection zone 102, the hydrophobic particles have the opportunity to attach to the bubbles. Once the hydrophobic particles are attached to the bubbles in the collection zone 102, they are transported to the cleaning zone 104. The cleaning zone 104 comprises a concentrate 112 and wash water injected via nozzles 114. The hydrophilic particles, which are not supposed to attach to the bubbles, but are entrapped between the hydrophobic particles, are washed in the cleaning zone 104 via the wash water and be rejected into the suspension, and the remaining concentrate 112 contains the extracted minerals.

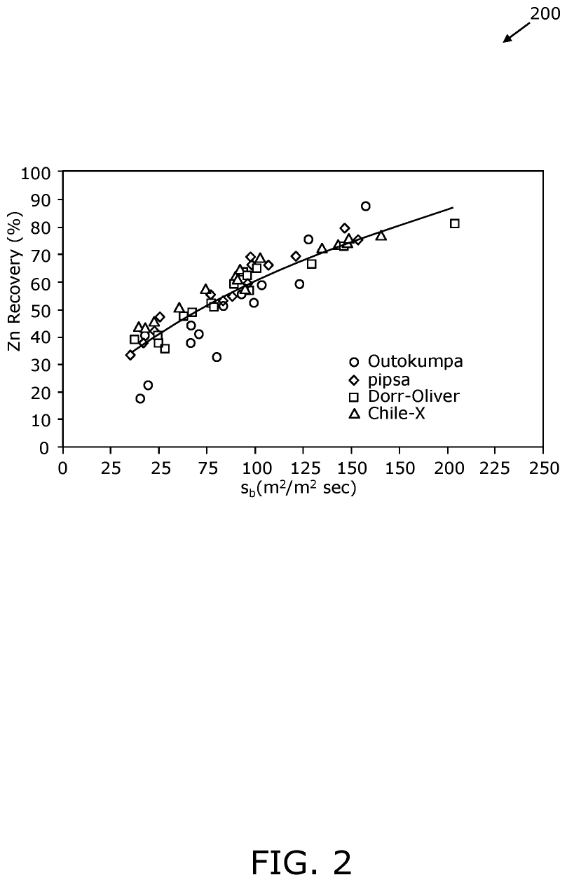

Referring to FIG. 2, there is shown a graphical depiction of a plot 200 showing a relationship between a bubble surface area flux (Sb) and zinc (Zn) recovery as implemented in a flotation chamber, in accordance with one or more embodiments of the present disclosure. The plot 200 depicts the relationship between the bubble surface area flux Sb and the zinc recovery. Herein, the surface area flux (Sb) is the ratio between a superficial gas rate and a bubble diameter. The plot 200 provides a relationship as,

Sb=6Jg/db≈5.5Eg (from Finch et al., 2000)

The Drift-Flux analysis uses the above relationship for predicting the bubble diameter.

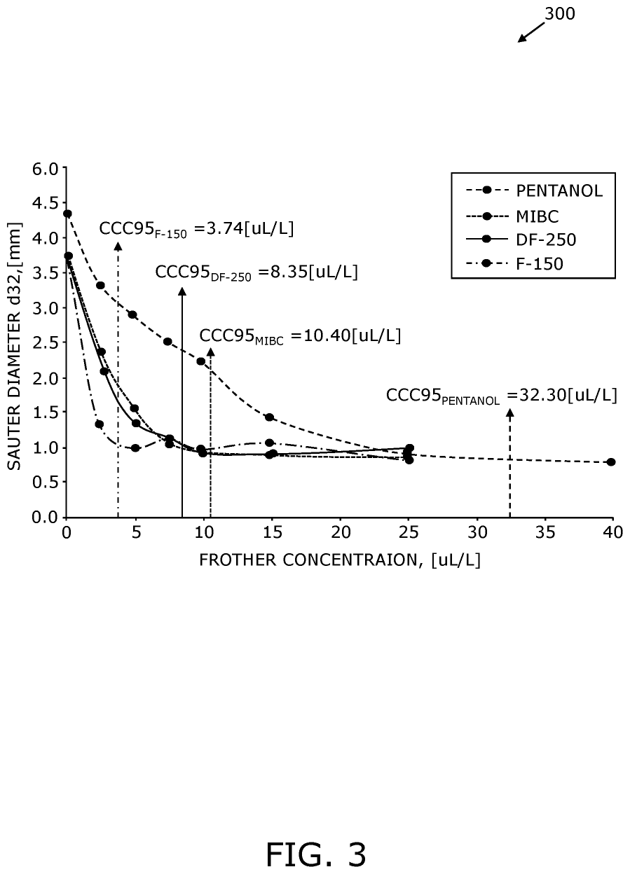

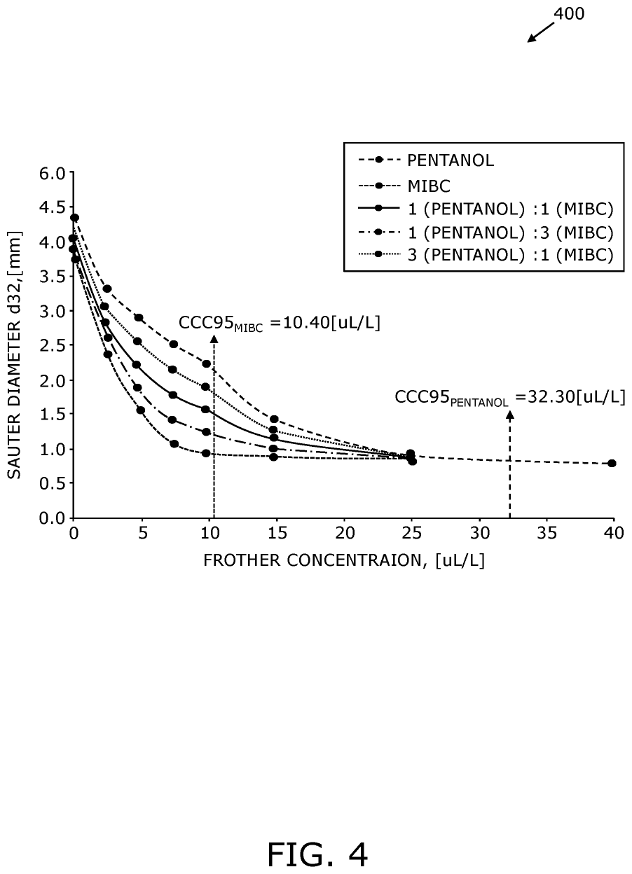

Referring to FIG. 3, there is shown a graphical depiction of a plot 300 showing relationship between a Sauter diameter (d32) and a frother concentration for different chemicals as implemented in a flotation chamber, in accordance with one or more embodiments of the present disclosure. The plot 300 depicts the effect of the dosage and chemical nature of the frother on the bubble diameter (average diameter Sauter d32, [mm]), for a chamber of 0.8 [m3] that operates with a superficial gas velocity (Jg)=0.5 [cm/s].

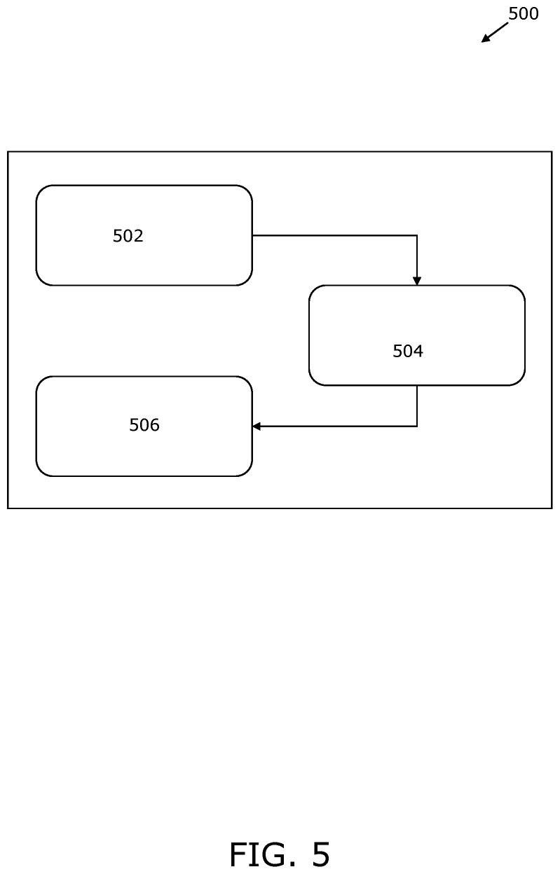

Referring to FIG. 4, there is shown a graphical depiction of a plot 400 relationship between a Sauter diameter (d32) and a frother concentration for various mixtures of pentanol and Methyl isobutyl carbinol (MIBC) as implemented in a flotation chamber, in accordance with one or more embodiments of the present disclosure. The plot 400 depicts an impact of the dosage and proportion of the frother mixture of Pentanol and MIBC type on the bubble diameter (average diameter Sauter d32, [mm]) considering that the volume of the chamber under study is 0.8 [m3] and this equipment operates with a superficial gas velocity (Jg)=0.5 [cm/s].

Referring to FIG. 5, there is shown a block diagram of a machine learning model 500 for extraction of minerals ore, in accordance with one or more embodiments of the present disclosure. The machine learning model 500 comprises an input and output measurement block 502, an optimization block 504 and an operational block 506. The measurement block 502 makes input and output measurements of real time and historic data. The sampled real time and historic data of the block 502 are sent to the optimization block 504. The optimization block 504 optimizes the operation of the columnar chambers to ensure quality of the final concentrate and reduce variability of the final concentrate. The conditions required for optimization are implemented in the operational block 506. The operational block 506 is a robust operational system to give stability to the flotation process and to reach KPIs of operations.

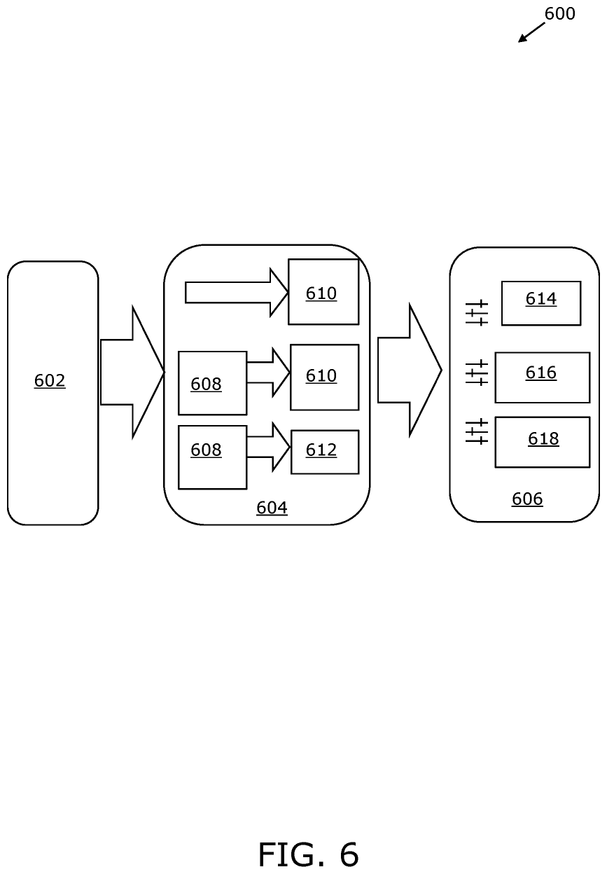

Referring to FIG. 6, there is shown a block diagram block diagram of a system 600 for implementing mineral recovery process, in accordance with another embodiment of the present disclosure. The system 600 comprises a data block 602, a predict block 604 and an optimize block 606. The data block 602 provides data input. The data input may be a design, a drawing and a report, column height, column parameter, solid density, liquid density and the like of the flotation chamber for number of applications. The data input may also provide a historical data upon which neural networks may be trained. The predict block 604 comprises two virtual sensors block 608, prediction blocks 610 and an EDP model 612. The virtual sensors block 608 includes virtual sensors that measures the parameters of the mineral recovery process in the flotation chamber. The virtual sensors block 608 measures the initial variables and the range variables depending on the input by the data block 602. The prediction blocks 610 includes one or more neural networks. Depending upon the historic data obtained from the data block 602, the neural network of the prediction block 610 is trained. The training of the neural network may be done by using a number of algorithms such as, supervised learning algorithm, unsupervised learning algorithms and reinforcement learning algorithm. For example, if the supervised learning algorithm is used, the historic data comprising an input data set with respective output data set may be provided as the input to the neural network for training. The neural network may learn a rule to map each input data of the historic data to respective output data of the historic data. Once trained, the data obtained from the virtual sensors block 608 and the data block 602 are given as input to the neural network. Herein, the neural network predicts according to the received inputs and set of outputs are generated. The outputs generated from the prediction block 610 denote the values of the variables needed to optimize the bubble diameter and the gas hold-up values in the mineral recovery process. The optimize block 606 includes optimized values of air flow chamber denoted by the block 614, the pulp and foam levels denoted by the block 616, and the reagent dosage denoted by the block 618.

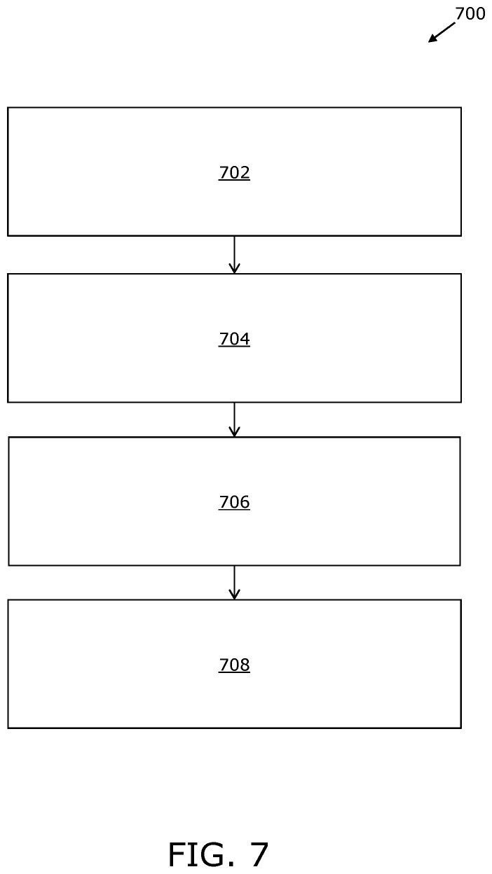

Referring to FIG. 7, there is shown a flowchart 700 of a method for optimizing a mineral recovery process, in accordance with one or more embodiments of the present disclosure. At step 702, the method includes implementing a machine learning model, trained on historic data related to the mineral recovery process, to determine operational parameters for the mineral recovery process based on a geometry of the flotation chamber and properties of the ore material.

At step 704, the method includes simulating the mineral recovery process using ranges of the operational parameters for the mineral recovery process to determine a factor representative at least of a relationship between a gas hold-up value and a bubble diameter value for the mineral recovery process. At step 706, the method includes determining the gas hold-up value and the bubble diameter value based on the operational parameters and the determined factor.

At step 708, the method includes training the machine learning model based on the determined gas hold-up value and bubble diameter value to control the operational parameters of the mineral recovery process to achieve higher throughput of recovered minerals from the ore material.

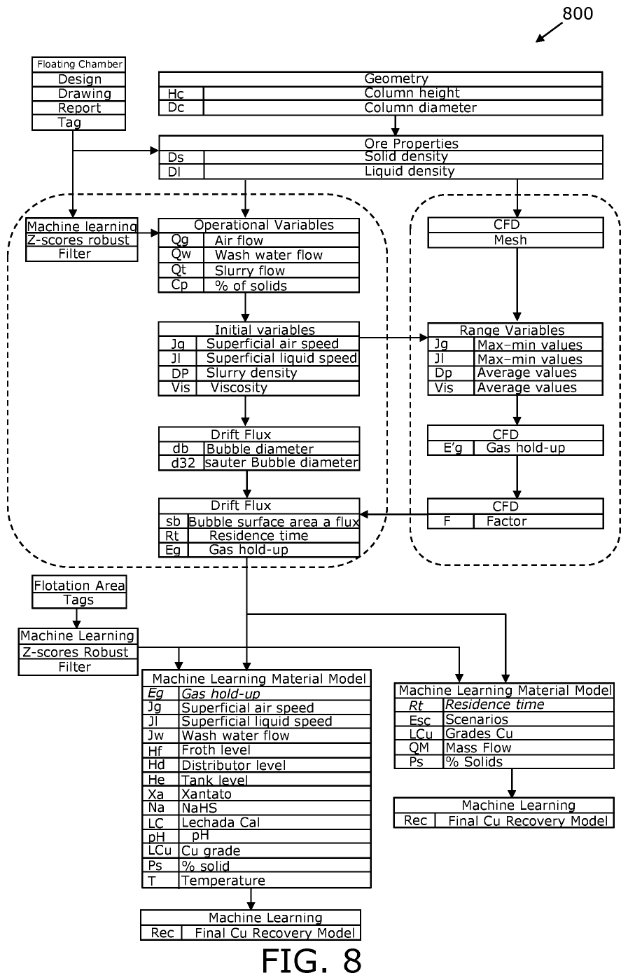

Referring to FIG. 8, there is shown a process flow diagram 800 of a mineral recovery process, in accordance with one or more embodiments of the present disclosure. The process flow diagram 800 utilizes information about flotation chamber, geometry, ore properties and implement machine learning to determine operational variable table, and therefrom initial variables. Herein, the information related to the floatation chamber includes a design, a drawing, a report and a tag related to the floatation chamber. The design may include a plan depicting how the floatation chamber may work. The drawing may include physical specification, like dimensions, of the floatation chamber. The report may provide details pertaining to working of the floatation chamber for a number of applications. The tag may be a label for identifying the floatation chamber, say from multiple floatation chambers. First, the information related to the flotation chamber are sent to a geometry module to deduce geometrical parameters of the flotation chamber such as, a column height and a column diameter. Then, the information related to the flotation chamber is also sent to a machine learning model that may utilise Z-scores robust filter. Thereafter, the geometrical parameters are sent to the ore properties module to determine ore properties parameter such as, a solids density and a liquids density of the ore. Subsequently, determined ore properties parameter such as, a solids density and a liquids density of the ore are sent to the computational fluid dynamics (CFD) model that utilises mesh technique to determine the ore properties parameter. Then, machine learning model and the determined ore properties parameter are used to find adjustable operational parameters. Herein, operation variables such as, air flow, wash water flow, slurry flow and percentage of solids are determined and sent to an initial variable module. Further, the initial variable module determines initial variables such as, superficial air speed, superficial liquid speed, slurry density and viscosity. Thereafter, the initial variables and the CFD model are utilised to find ranges of initial variables such as, maximum and minimum values of the superficial air speed, maximum and minimum values of the superficial liquid speed, average value of slurry density and average value of viscosity. Further, the ranges of initial variables are utilized in the CFD model to determine intermediate gas hold-up in order to calculate a factor (f) representing relationship between the bubble diameter value and the gas hold-up. Subsequently, the initial variables are used for drift flux computation. Herein, bubble diameter and Sauter bubble diameter are found. Furthermore, the drift-flux analysis is used to determine optimal operational parameters such as, bubble surface area flux, residence time and gas hold up using the calculated factor. Finally, these determined operational parameters are used in machine learning models to optimize the mineral recovery process.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™, C++, Python, Cython: C-Extensions for Python or Perl™ using, for example, conventional or object-oriented techniques.

The computer program code may be stored as a series of instructions, or commands on a non-transitory computer-readable medium, such as a random-access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

### REFERENCES

[1] Finch, J. A., Xiao, J., Hardie, C., Gomez, C. O., 2000. Gas dispersion: bubble surface area flux and gas hold-up. Minerals Engineering 14, 365-372
[2] Gorain, B. K., Franzidist, J. P., and Manlapig, E. V., 1996. Studies on impeller type, impeller speed and air flow rate in an industrial scale flotation cell. part 4: effect of bubble surface area flux on flotation performance

1. A method for optimizing a mineral recovery process from ore material using a flotation chamber, the method comprising:
implementing a machine learning model, trained on historic data related to the mineral recovery process, to determine operational parameters of the flotation chamber, for the mineral recovery process based on a geometry of the flotation chamber and properties of the ore material; simulating the mineral recovery process using ranges of the determined operational parameters for the mineral recovery process to determine a factor representative at least of a relationship between a gas hold-up value and a bubble diameter value for the mineral recovery process;
determining the gas hold-up value and the bubble diameter value based on the determined operational parameters and the determined factor; and
utilizing the determined gas hold-up value and bubble diameter value to determine optimized values of the operational parameters for the mineral recovery process by implementing a virtual sensor, to achieve higher throughput of recovered minerals from the ore material.

2. The method according to claim 1, wherein the machine learning model computes robust z-scores to determine the operating parameters for the mineral recovery process.

3. The method according to claim 1, wherein at least one of the gas hold-up value and the bubble diameter value are calculated using a drift flux analysis.

4. The method according to claim 1, wherein the mineral recovery process is simulated using computational fluid dynamics techniques.

5. The method according to claim 1, wherein the operational parameters comprise operational variables as determined by the machine learning model and initial variables as calculated from the operational variables.

6. The method according to claim 5, wherein the computational fluid dynamics techniques utilize ranges of the initial variables to determine the said factor.

7. The method according to claim 5, wherein the operational variables comprise one or more of air flow (Qg), wash water flow (Qw), slurry flow (Qt) and percentage of solids (Cp), and wherein the calculated initial variables comprise one or more of superficial air speed (Jg), superficial liquid speed (Jl), slurry density (Dp), temperature (T), dose (Ra) and viscosity (Vis).

8. A method according to claim 1 further comprising training the machine learning model based on the determined gas hold-up value and bubble diameter value to control the operational parameters of the mineral recovery process.

9. A system for implementing the method for optimizing a mineral recovery process from ore material using a flotation chamber of claim 1.

10. A computer program product comprising instructions which, when the program is executed by a computer, cause the computer to carry out the method for optimizing a mineral recovery process from ore material using a flotation chamber of claim 1.
